(19) United States
(12) Patent Application Publication
(10) Pub. No.: US 2011/0175302 A1
(43) Pub. Date: Jul. 21, 2011

(54) Manually Propelled Vehicle with Continuous Track

(76) Inventors: David Sherman, London (GB); Yekutiel Sherman, London (GB); Robert Taylor, Berkshire (GB)

(21) Appl. No.: 13/120,307

(22) PCT Filed: Aug. 18, 2009
(86) PCT No.: PCT/GB09/02011

§ 371 Date: Mar. 22, 2011

(30) Foreign Application Priority Data
Sep. 24, 2008 (GB) 0817520.0

(51) Int. Cl. B62B 9/02; B62B 7/04; B62B 5/02

(52) U.S. Cl. 280/5.22; 280/28.5

(57) ABSTRACT

A manually propelled vehicle (1) comprises a frame (11) and a plurality of wheels (17, 23) secured to the frame (11) for conveying the vehicle (1) in one mode of operation. The vehicle (1) further comprises at least one continuous track assembly (3) mounted on the frame (11) and defining an upper tread (63a) and a lower tread (63b). The distance between the upper tread (63a) and lower tread (63b) can be changed from a retracted condition to an extended condition. In the extended condition, the lower tread (63b) forms the ground engaging surface of the vehicle (1) for conveying the vehicle (1) in a second mode of operation thereof. The vehicle (1) further comprises a seat (5) pivotally mounted to the frame (11) and means to tilt the seat (15) rear-wardly when ascending or descending an incline.

The present invention relates to a manually propelled, wheeled vehicle with a continuous track which can be selectively deployed to assist with negotiating steps or uneven or soft ground. In particular, the present invention relates to pushchairs but it is applicable to other manually propelled, wheeled vehicles, such as wheelchairs or wheeled trolleys.

The most common pushchair designs comprise a frame supported on either three or four wheels, or sets of wheels. These designs provide a convenient method of transporting an infant over flat or solid ground. However, when encountering an obstacle, such as uneven or soft ground, or a flight of stairs, the three or four wheeled design becomes difficult to operate without additional assistance and results in an uncomfortable experience for the occupant.

One approach to overcome these shortcomings is to provide a pushchair with a continuous track to span the obstacle or to distribute the vehicle weight over a larger area. An example of this type of arrangement can be found in WO 2007/023277, which provides a chair on wheels, wherein the wheels are bounded by two continuous tracks. This has the disadvantage that, when negotiating an obstacle which extends above the axis of the track wheels, the pushchair must be tipped back and forth to prevent the track from becoming embedded in the obstacle. A further disadvantage is that when a substantial length of the continuous tracks are in contact with the ground, the frictional force between the two is not easily overcome, making it difficult to change the direction of the pushchair during normal use. Furthermore, the rolling resistance of the continuous track is greater than that of a set of wheels, causing the user difficulty in operating the pushchair during normal use.

A different approach can be found in GB 2327643, which discloses a set of continuous tracks for attachment to a pushchair which can be lowered and locked into position beneath the pushchair to enable it to be pulled up or lowered down a flight of stairs. This has the disadvantage that the low profile track attachment provided may become embedded in an obstacle and must be lifted, along with the pushchair, onto the first step of a flight of stairs. Moreover, the attachment of the rear set of wheels to the mid-section of the track makes the invention unsuitable for use on any obstacle on flat ground.

The present invention provides manually propelled vehicle comprising: a frame; a plurality of wheels secured to the frame for conveying the vehicle in one mode of operation thereof; and at least one continuous track assembly mounted on the frame and defining an upper tread and a lower tread, wherein the distance between the upper tread and the lower tread can be changed from a retracted condition to an extended condition, and wherein in the extended condition the lower tread forms the ground engaging surface of the vehicle for conveying the vehicle in a second mode of operation thereof; and further comprising a seat pivotably mounted to the frame and means to tilt the seat rearwardly when ascending or descending an incline.

In this way, a compact continuous track assembly is provided which can be extended for improved ease of use and to avoid becoming embedded in an obstacle or soft/rough ground.

Preferably, the continuous track assembly comprises an endless, elastic belt and a plurality of rollers defining a path for the belt, wherein some of the rollers can be displaced relative to the other rollers, thereby defining a longer path and stretching the belt into the extended condition. Use of an elastic belt provides a simple means to extend the distance between the upper and lower treads.

Advantageously, the belt is in tension in both the retracted and extended conditions, thereby keeping the mechanism in the compact retracted state when not in use.

Typically, the assembly further comprises at least one front roller, at least one rear roller, and a plurality of central rollers, the central rollers rotatably secured to a common mounting, and means to push the common mounting away from the upper tread to cause the belt to extend.

The means to push the mounting may comprise a rotatable arm and the vehicle may further comprise a first release mechanism operable in a first direction to rotate the arm and push the mounting.

Conveniently, the first release mechanism may comprise a rotatable foot pedal and a linkage connecting the pedal to the rotatable arm.

Preferably the vehicle further comprises means to retain the continuous track assembly in the extended condition, for safety reasons, to ensure the track cannot retract unexpectedly.

The first release mechanism is preferably operable in a second direction, opposite to the first direction, to unlock the locking means and allow the continuous track assembly to return from the extended condition to the contracted condition under the action of the tension of the belt.

By way of example, the belt may be formed from neoprene.

Preferably the exterior surface of the belt is provided with an uneven texture, for enhanced grip.

It is also preferable if the interior surface of the belt is provided with a moulding for engagement with a correspondingly shaped portion of the rollers, to avoid slipping off the rollers.

The continuous track assembly preferably further comprises a casing partially covering the belt and rollers, to protect the user of the vehicle from dirt on the track.

The continuous track assembly is preferably mounted on the frame for displacement between a stowed position and a deployed position, so that it does not inhibit normal use of the vehicle when it is not required.

To do this, one of the frame or the continuous track assembly may further comprise at least one guide pin engaging in and movable along at least one guide slot formed in the other of the frame or the continuous track assembly.

To ensure safe operation, preferably means is provided to lock the continuous track assembly in the stowed position or in the deployed position respectively and a second release mechanism is provided operable to release the continuous track assembly and to allow displacement between the stowed and deployed positions.

The locking means may comprise a pin resiliently biased by spring means and the second release mechanism may comprise a handle and a linkage operable to move the pin in opposition to the spring means.

In the extended position, the upper tread is preferably longer than the lower tread and the continuous track assembly defines a rearward facing tread which extends downwardly and forwardly from the upper tread to the lower tread.

Likewise, the continuous track assembly preferably defines a forward facing tread which extends downwardly and rearwardly between the upper tread and the lower tread.

These angled faces assist with negotiating obstacles without the need to lift the vehicle.

In these cases, the forward and rearward treads are substantially unsupported in their respective central regions so as to provide a shock absorbing capability.

Advantageously, the length of the lower tread is sufficient to span the nosing of three steps of a standard flight of steps. This ensures a smooth ride up or down steps.

The distance between the upper tread and the lower tread in the extended condition is preferably greater than the height of the riser of a standard step. This makes it easier to move the vehicle on to or off a flight of steps.

For safety reasons, it is preferred if the continuous track assembly can only be moved between the retracted and extended conditions when the track assembly is in the deployed position.

Advantageously, the vehicle further comprises a pivot mechanism which can be selectively deployed so as to extend beyond the lower tread of the continuous track assembly when it is in the extended condition in order that the pivot mechanism becomes the grounding engaging surface of the vehicle in place of the lower tread, to enable steering of the vehicle.

The pivot mechanism typically comprises as least two rollers mounted on extendible parts of the vehicle frame.

In one embodiment, the vehicle further comprises a handle for use in manually propelling vehicle.

The handle may be rotatable relative to the frame about two mutually perpendicular axes and extendable in length.

In this example, the seat is initially locked in the upright position, rotation of the handle about one axis releases the seat and rotation of the handle about the second axis and extension of the handle is operable to tilt the seat backwards.

The present invention will now be described in detail, by way of example only, with reference to the accompanying drawings, in which:

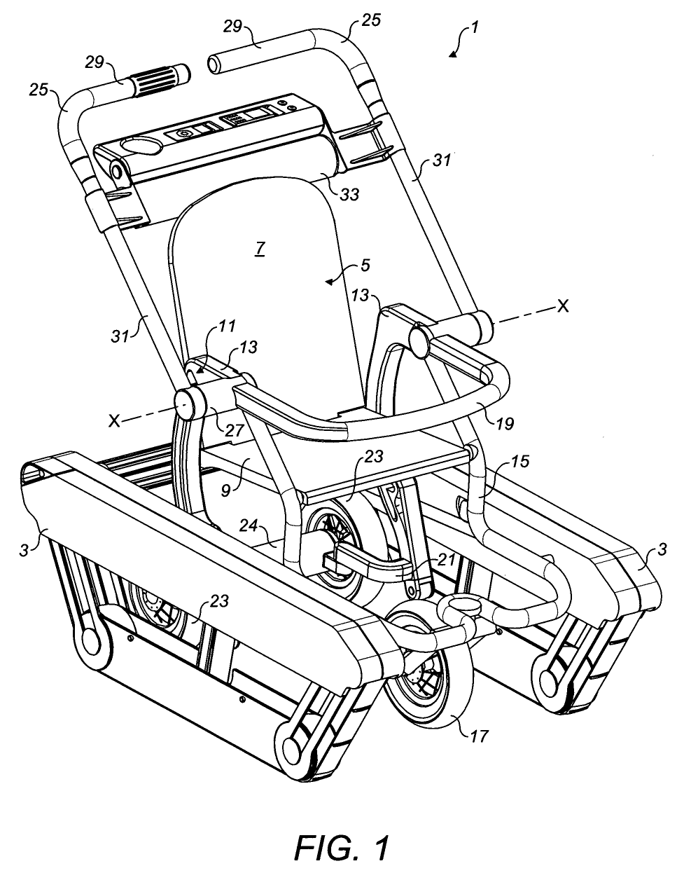

FIG. 1 is a front perspective view of a pushchair in accordance with one embodiment of the present invention, showing the track assembly fully deployed with the continuous track extended;

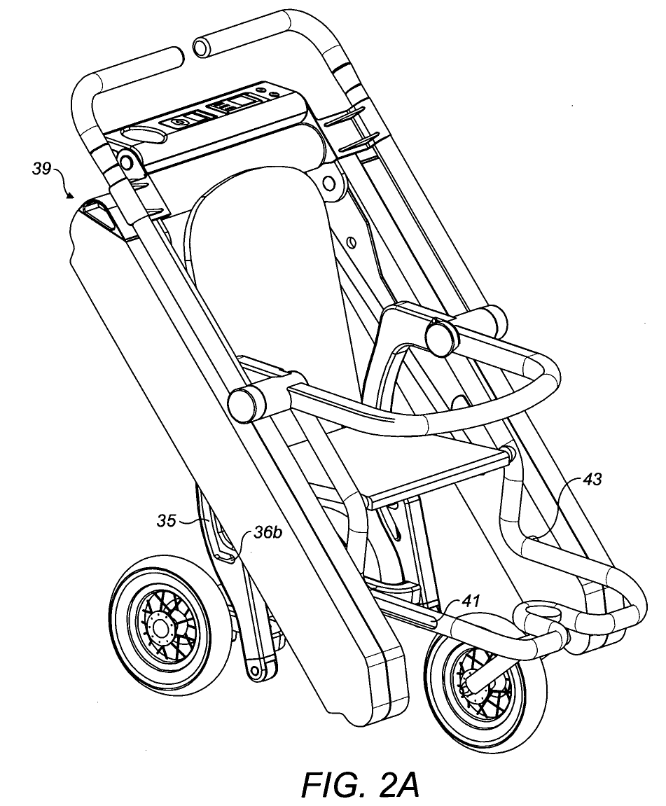

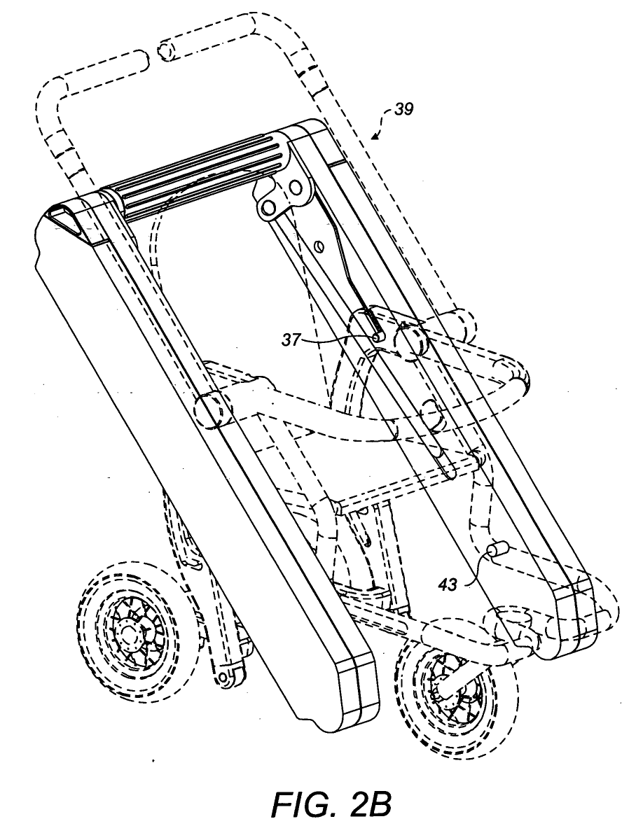

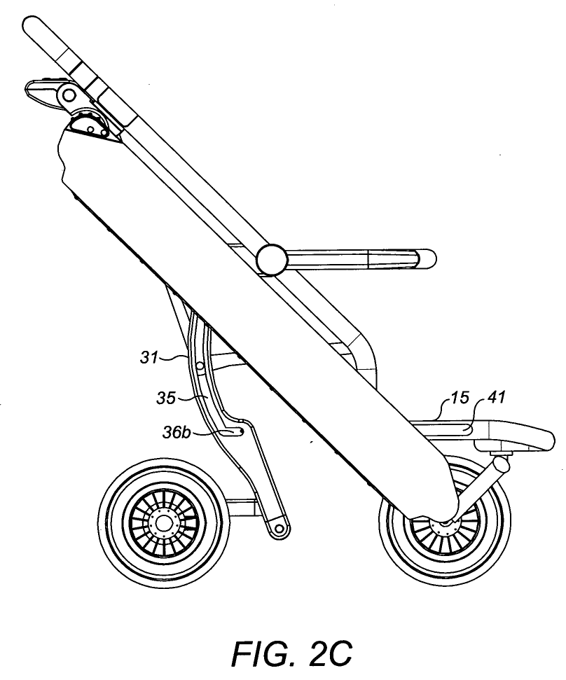

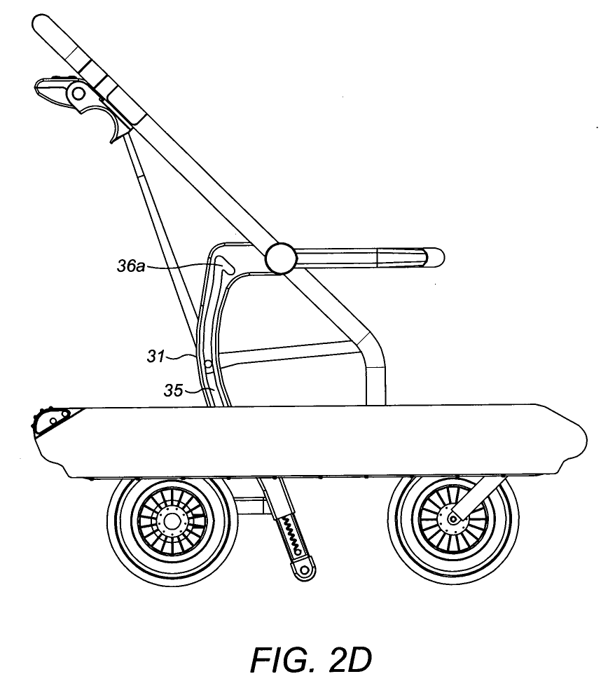

FIG. 2A is a front perspective of the pushchair of FIG. 1 with the track assembly in the stowed condition;

FIG. 2B is similar to FIG. 2A but showing the pushchair frame in ghost lines in order to show details of the track assembly more clearly;

FIG. 2C is a side view of the pushchair of FIG. 2A;

FIG. 2D is a side view similar to FIG. 2C but with the track assembly partially deployed with the continuous track contracted;

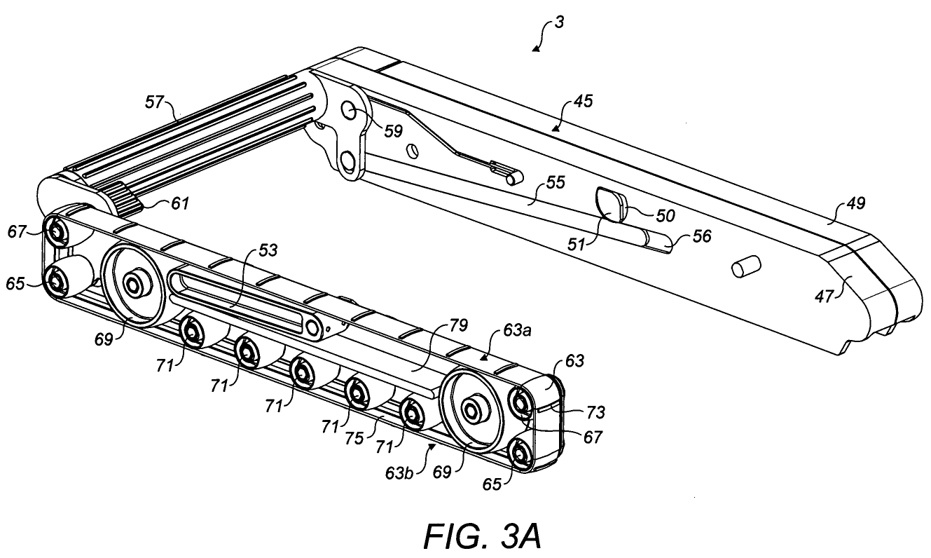

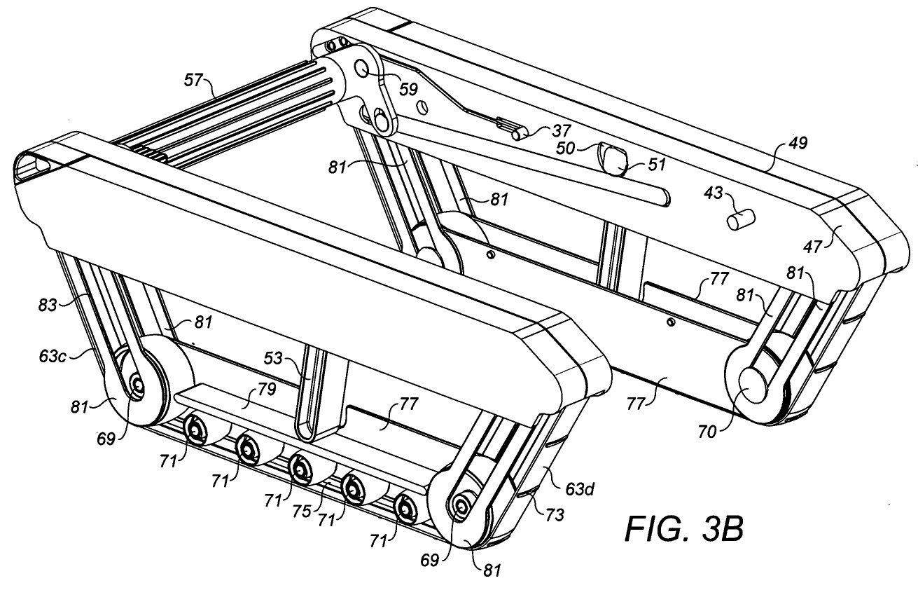

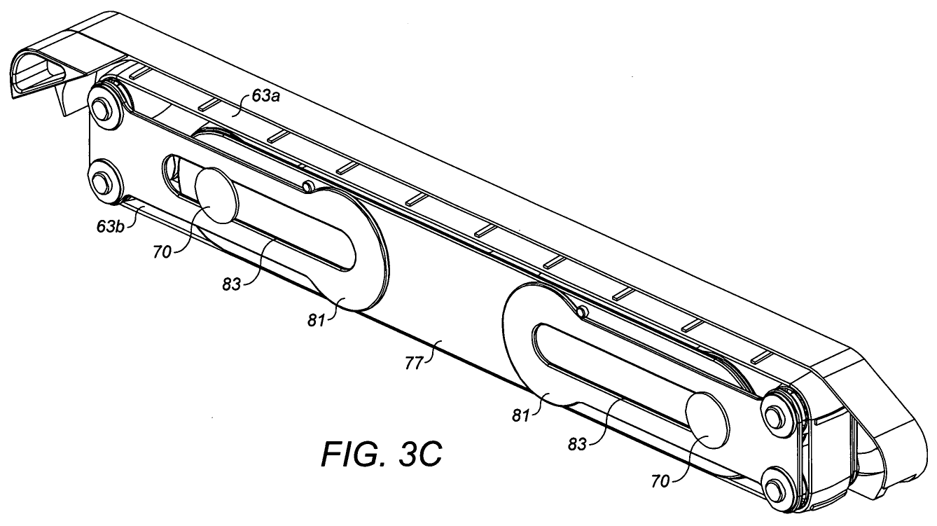

FIG. 3A is a front perspective view of parts of the track assembly with the continuous track in the contracted condition;

FIG. 3B is a front perspective view of the track assembly in the fully deployed condition with the continuous track extended;

FIG. 3C is a perspective view of parts of one track assembly with the continuous track contracted;

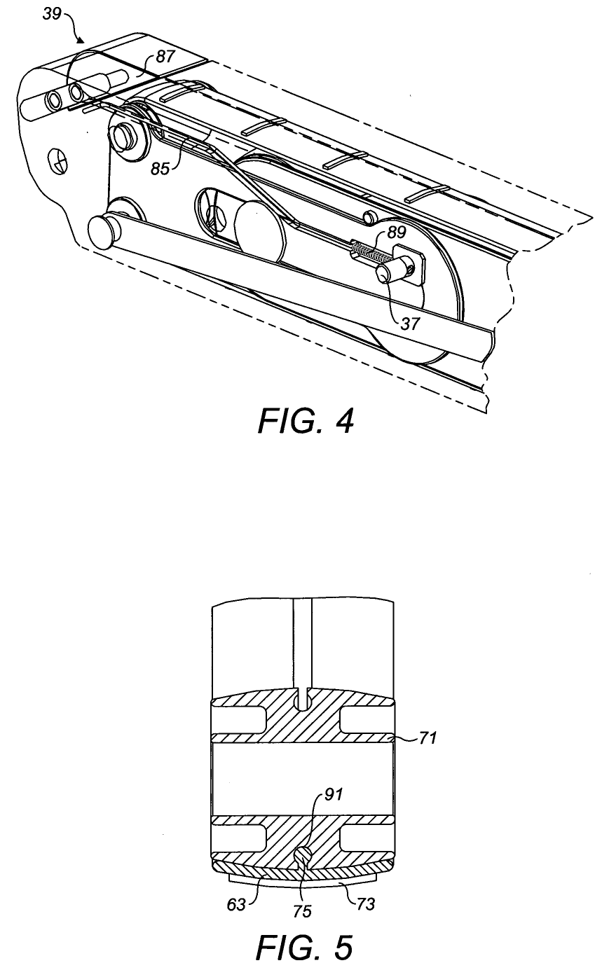

FIG. 4 is a detailed view of parts of one track assembly;

FIG. 5 is a cross section of one base roller of the track assembly engaged with the continuous track;

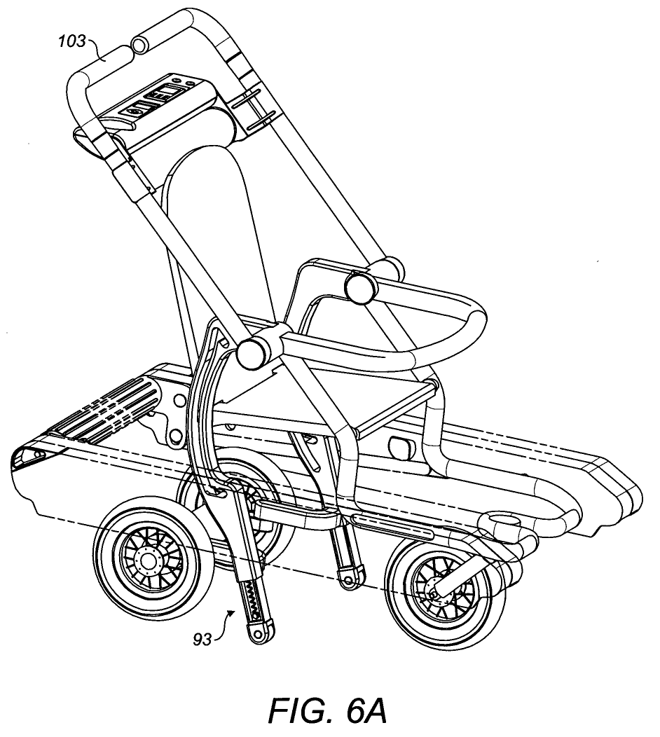

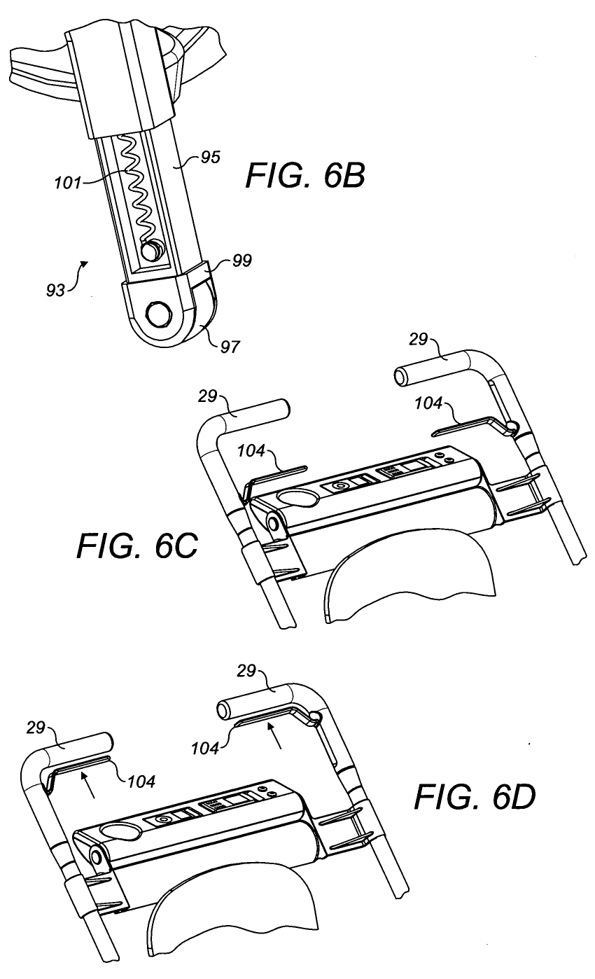

FIG. 6A is a front perspective view of the pushchair of FIG. 1, with the track assembly in the partially deployed position but shown in ghost lines, and the central pivot assembly of the pushchair frame in the deployed condition;

FIG. 6B is an enlarged detailed view of the central pivot assembly of FIG. 6A;

FIGS. 6C and 6D show the pushchair handle bars with an alternative form of actuator for the central pivot assembly;

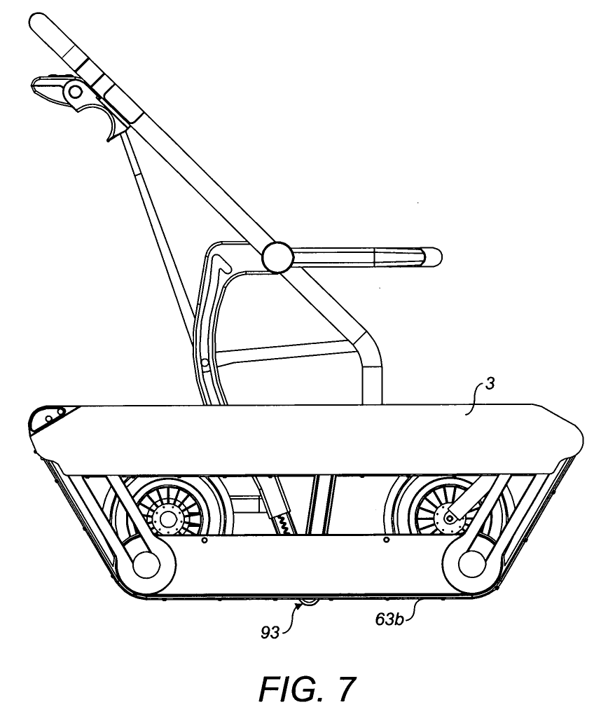

FIG. 7 is a side view of the pushchair of FIG. 1, with the central pivot assembly of the pushchair frame in the deployed condition;

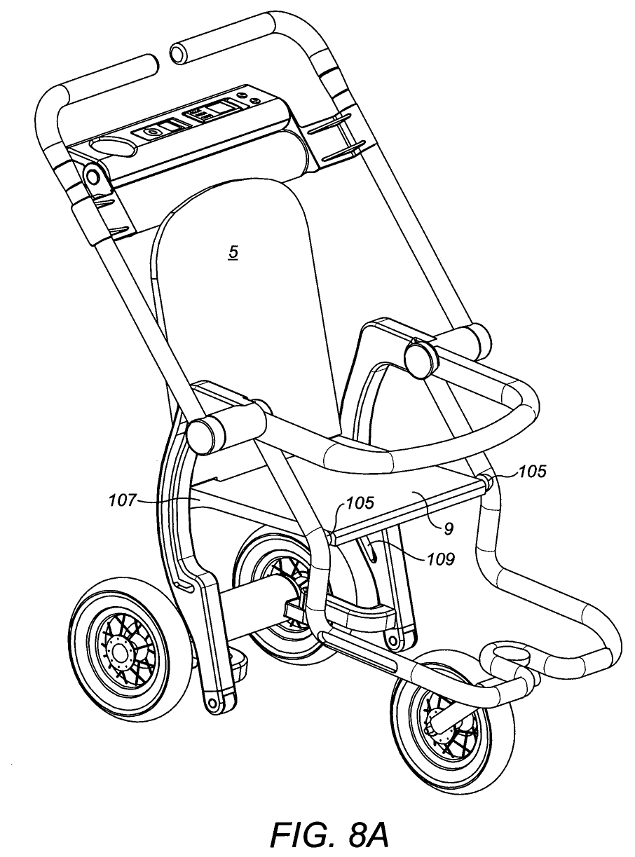

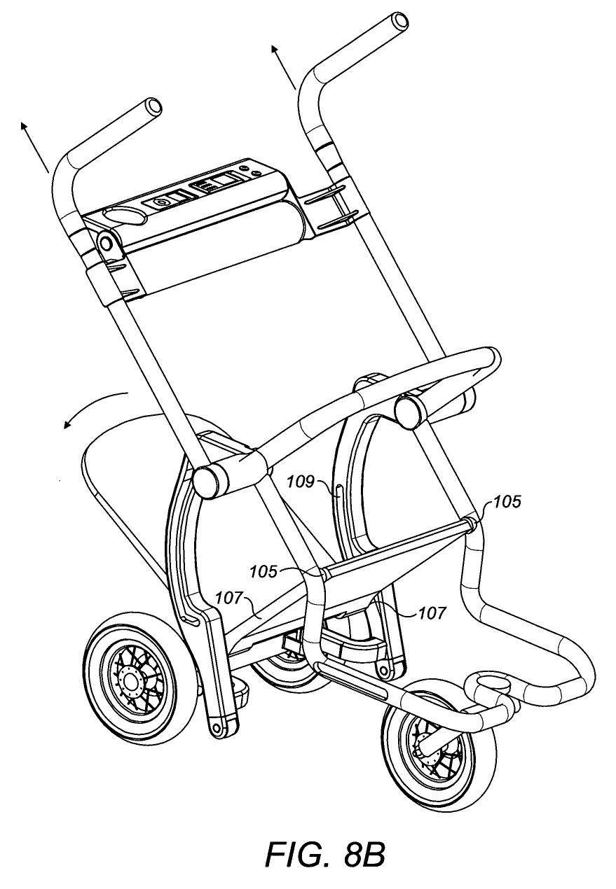

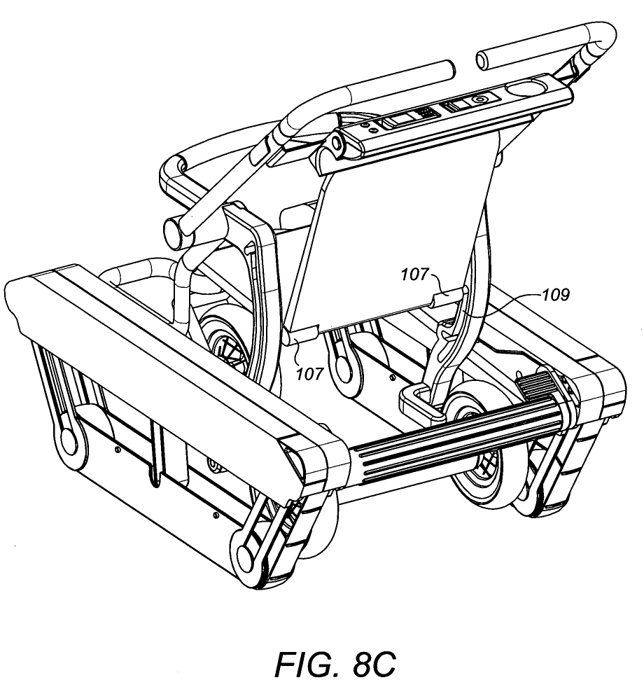

FIG. 8A is a front perspective view of the pushchair of FIG. 1, without the track assembly;

FIG. 8B is a front perspective view of the pushchair of FIG. 8A showing the seat in the reclined position;

FIG. 8C is a rear perspective view of the pushchair of FIG. 1;

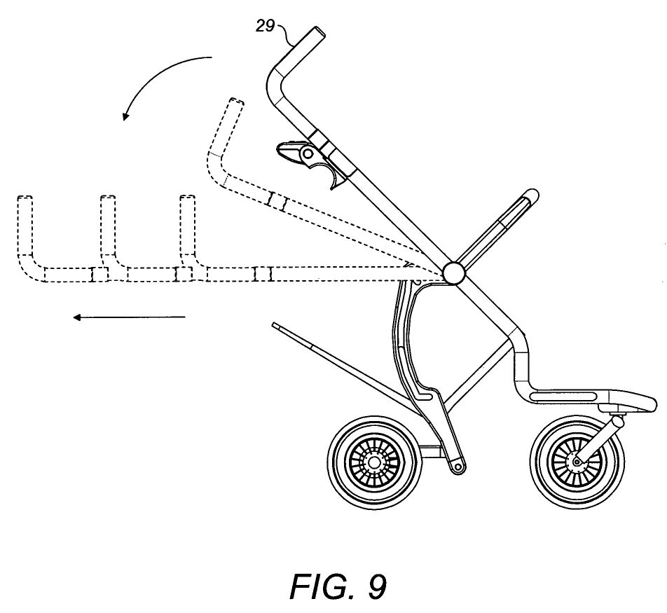

FIG. 9 is a side view of the pushchair of 8B, showing the adjustment range of the handles;

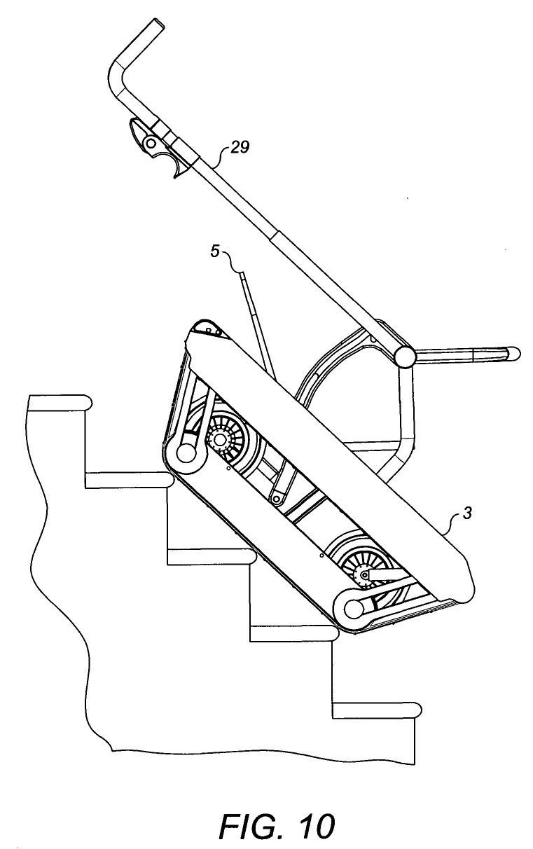

FIG. 10 is a side view of the pushchair of FIG. 1, showing the pushchair in use on a flight of stairs, with the seat in the reclined position and the handles extended and rotated downward;

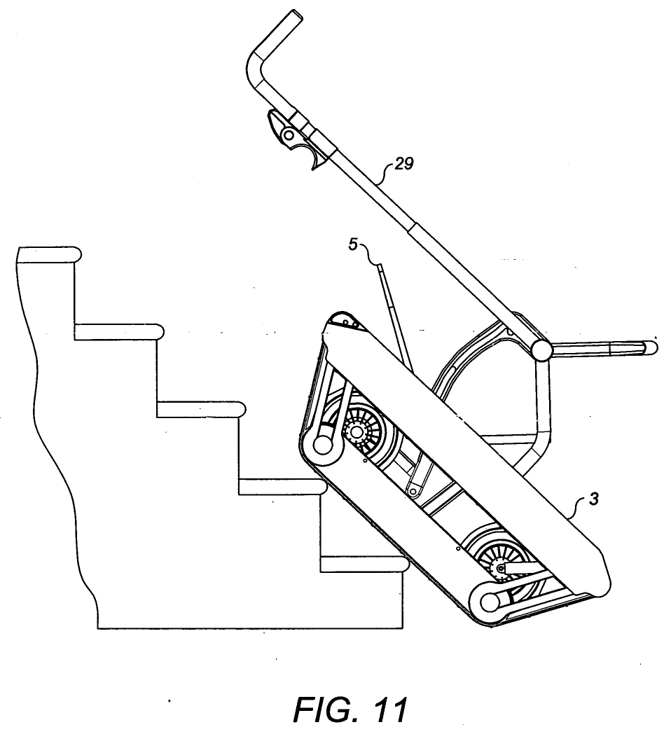

FIG. 11 is a side view of the pushchair of FIG. 10, showing the pushchair at the transition between a flight of stairs and flat ground;

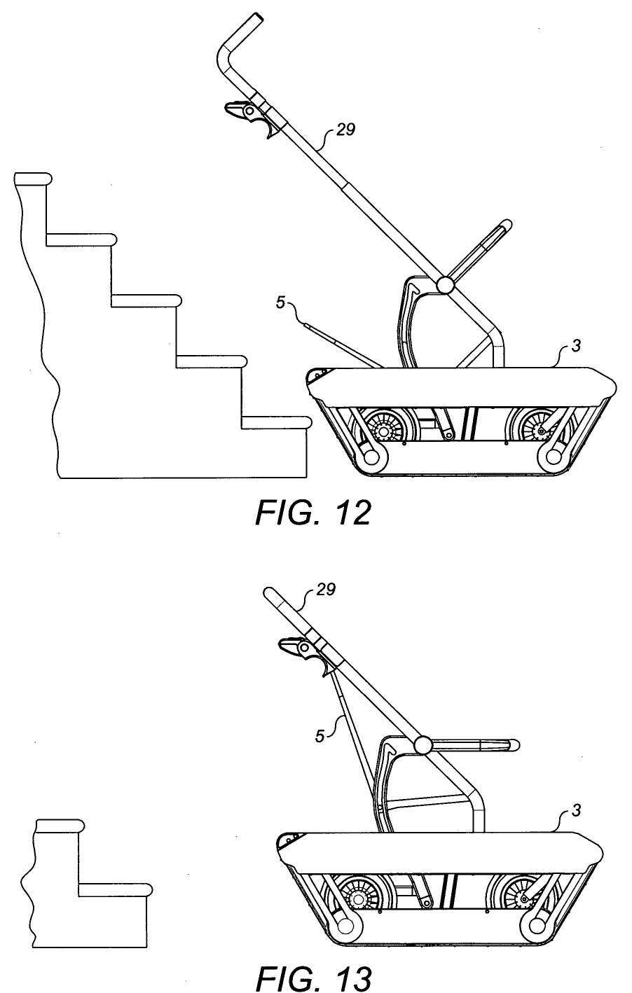

FIG. 12 is a side view of the pushchair of FIG. 10, showing the pushchair on flat ground whilst the user is still on a flight of stairs;

FIG. 13 is a side view of the pushchair of FIG. 10, showing the pushchair at the foot of a flight of stairs, with the seat in the upright position and the handles returned to the position shown in FIG. 1;

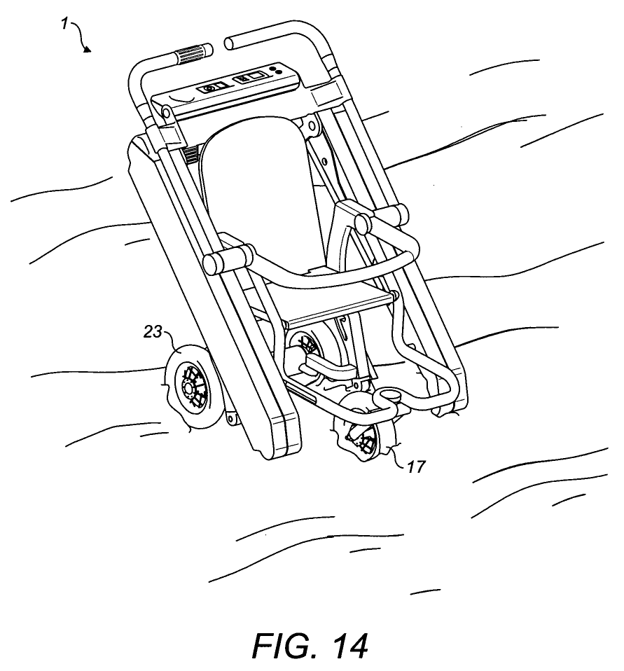

FIG. 14 is a front perspective view of the pushchair of FIG. 2A negotiating soft or uneven terrain; and

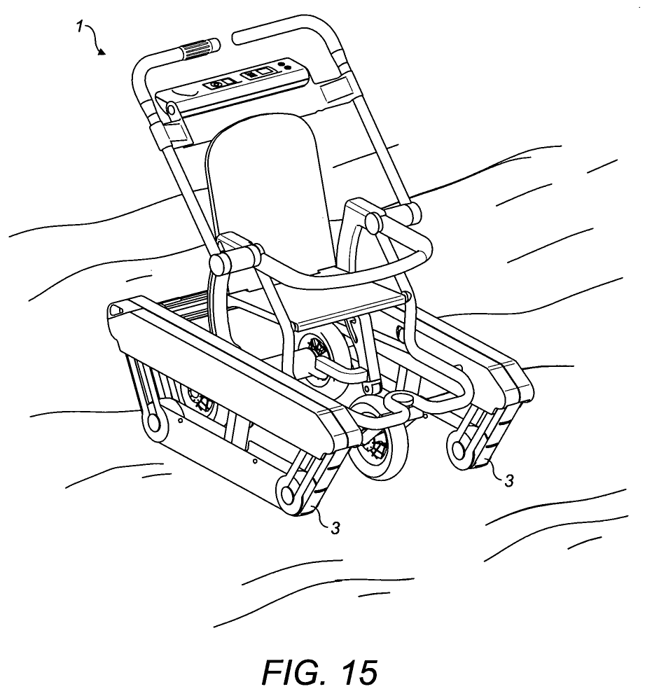

FIG. 15 is a front perspective view of the pushchair of FIG. 1 negotiating soft or uneven terrain with the track assembly fully deployed.

With reference to FIG. 1, a pushchair 1 in accordance with one embodiment of the present invention is shown with a extendable continuous track assembly 3 mounted on each side of the pushchair 1. Each track assembly 3 is shown in the deployed and extended condition to convey the pushchair 1. Each continuous track assembly 3 is pivotally and slidably connected to the pushchair 1 as will be described in greater detail below.

The pushchair 1 comprises a seat 5 formed of a seat back 7 and a seat base 9. The seat base 9 is supported by a frame 11. In this example, the frame 11 comprises two side members 13, one on each side of the seat 5, a front member 15 having at least one front wheel 17 rotatably attached thereto, and pivotable about a vertical axis for steering, and a safety bar 19 extending between side members 13. The pushchair 1 further comprises two rear legs 21 (only one of which is visible in FIG. 1) each having at least one rear wheel 23 rotatably attached thereto. The rear wheels are mounted on a common rear axle 24, and may include a suspension system in a conventional manner.

Two handles 25 are each rotatably connected to the frame 11 by means of a pivot mechanism 27, such that the handles 25 can be rotated about a horizontal axis x-x of the pivot mechanism 27 relative to the frame 11. The pivot mechanism 27 includes spring means (not shown) to support the weight of the handles 25 and means to lock the handles 25 in the desired position relative to the frame 11.

Each handle 25 comprises a substantially L-shaped handle bar 29 connected to an elongate handle arm 31 extending downwards to the pivot mechanism 27. The handle bars 29 are connected to the handle arms 31 such that the handle bars 29 are slidable telescopically along the longitudinal axis of the handle arms 31 and may be rotated around the longitudinal axis of the handle arms 31. A locking means (not shown) can lock the handle bars 29 in the desired position relative to the handle arms 31.

A cross member 33 is connected between the handle arms 31, toward the upper ends of the handle arms 31. The cross member 33 acts as a shield to prevent debris from contacting the occupant when the continuous track assemblies 3 are in the stowed condition. The cross member 33 can also be used as a base onto which peripheral features, such as a cup holder or a personal entertainment device, may be mounted or connected.

FIGS. 2A, 2B and 2C show the pushchair 1 of FIG. 1 with each continuous track assembly 3 in the contracted and stowed condition in which they are substantially parallel to the handle arms 31. FIG. 2D shows the pushchair of FIG. 1 with each continuous track assembly 3 in a partially deployed condition in which the continuous track is still retracted and a central pivot mechanism (described further below).

The frame side members 13 have guide channels 35, visible in FIGS. 2C and 2D along which a release pin 37 of a respective continuous track assembly 3 travels when the continuous track assembly 3 is moved between the stowed and deployed conditions. Each pin 37 is mounted on a rearward half of the respective track assembly 3, as shown in FIG. 2B. Each guide channel 35 has a notch 36a at its upper extremity (FIG. 2D) and another notch 36b at its lower extremity (FIG. 2C). The notches 36a and 36b are positioned such that each continuous track assembly 3 can be locked in place in the stowed condition, by engaging pin 37 in the upper notch 36a, or positioned in the deployed condition, by engaging pin 37 in the lower notch 36b. The release pins 37 are moved by means of a release mechanism 39, described in greater detail below.

The frame front member 15 has a guide channel 41 on each side, along which a guide pin 43 mounted on the forward half of each continuous track assembly 3 also travels when the continuous track assembly 3 is moved between the stowed and deployed conditions.

FIGS. 3A, 3B and 3C show parts of the two continuous track assemblies, joined by a foot bar 57. Each continuous track assembly 3 comprises a track housing 45 partially enclosing the continuous track and a number of rollers. For clarity, FIG. 3A illustrates the housing 45 on one side and the track and rollers on the other, although in practice each track assembly 3 includes both of these sub-assemblies.

The housing 45 is made up of an inner casing 47 and an outer casing 49. Typically, the track housing 45 is made from an impact-resistant injection moulded polymer, with good strength, toughness and rigidity characteristics and which, is not adversely affected by reasonable variations in temperature and humidity and which has good chemical resistance, such as acrylonitrile butadiene styrene (ABS).

Extending through an aperture 50 in the inner casing 47 is a priming arm gear 51 rotatably connected to the housing 45 and fixedly connected to a priming arm 53 located inside the housing 45. The priming arm gear 51 is in mesh with a link arm 55 extending along a recess 56 in the inner casing 47, extending towards the rear of the housing 45 where the link arm 55 is rotatably connected to the foot bar 57. The foot bar 57 is rotatably connected to the inner casing 47 of each housing 45 by means of a foot bar pivot 59 and extends between and substantially perpendicular to the two track housings 45.

The foot bar 57 includes an extension on the upper surface to form a release pedal 61 for rotating the foot bar 57 away from the ground, thus retracting the continuous track assemblies 3. Preferably the foot bar 57 and the release pedal 61 include a series of grooves or raised profiles on the contact surface to increase the frictional force between the bar or pedal and the foot of a user.

Each track housing 45 encloses the continuous track, which is formed by a flexible, elastic belt 63 running around a number of crowned rollers. Typically, the belt 63 is made from a waterproof, durable and expandable rubber, with good abrasion and chemical resistance properties, such as neoprene. It is also preferable if the belt material can be recyclable.

In this example, the belt 63 runs around four end rollers 65 and 67, two main rollers 69 and over five base rollers 71 to provide an upper tread 63a and a lower tread 63b. The length of the belt 63 is such that it is in a slightly extended state even when the continuous track assembly 3 is retracted. The tension in the belt 63 ensures that the continuous track assembly 3 remains retracted until the user activates the mechanism for extending it. Preferably the belt 63 has ribs 73 or other textured features on its outer surface to increase friction between the belt 63 and the surface on which the belt 63 is disposed. The belt 63 also has a moulded profile 75 along its inner surface for engaging with the crowned rollers, as described in greater detail below.

The base rollers 71 are located between two substantially parallel side plates 77 as best seen in FIG. 3B, and are rotatably connected to at least one of the side plates 77. The base rollers 71 have axes of rotation substantially perpendicular to the side plates 77. The side plates 77 are connected by a running plate 79 which is in contact with the priming arm 53. The main rollers 69 are rotatably connected to roller caps 70 located on the reverse side of the side plates 77 relative to the main rollers 69 (see FIG. 3C), such that the side plates 77 are positioned between the main rollers 69 and the roller caps 70. Each pair of end rollers 65 and 67 is rotatably connected to two substantially parallel track arms 81. The upper end rollers 67 are also rotatably connected to the housing 45, such that the track arms 81 may pivot about the upper end rollers 67. The track arms 81 include an elongate slot 83 with a slot width less than the diameter of the roller caps 70 and each of the track arms 81 is located between the corresponding side plates 77 and roller caps 70.

With reference to FIG. 4, the release mechanism 39 for releasing each continuous track assembly 3 from the stowed condition is shown in detail. The release mechanism 39 of each track housing 45 comprises a cable 85, typically of steel, connected at one end to a release handle 87 and connected at the other end to the release pin 37. The release handle 87 is connected to the housing 45 such that it is slidable relative to the housing 45. The release pin 37 is biased away from the release handle 87 by means of a spring 89.

With reference to FIGS. 1 to 4, the method of deploying and extending each continuous track assembly 3, starting from the stowed condition of FIGS. 2A, 2B and 2C, will now be described. The sequence of actions in one track assembly 3 is described, but it will be appreciated that the same actions occur simultaneously in the other track assembly.

The user pulls the release handle 87 rearwardly, away from the housing 45, which causes the cable 85 to compress the spring 89 and moves the release pin 37 out of the upper notch 36a and into the guide channel 35 on the frame side member 13. The continuous track assembly 3 can now be displaced towards the ground and rotated around as the guide pin 43 and the release pin 37 slide in their corresponding guide channels 35 and 41. This movement is preferably controlled by spring means such as a torsion spring, or friction means (not shown) connected to the guide pin 43.

When the continuous track assembly 3 is substantially parallel to the ground, as shown in FIG. 2D, the release pin 37 is urged into the lower notch 36b by the spring 89. Once the release pin 37 is in the notch 36b, it is not possible for the continuous track assembly 3 to move vertically relative to the frame 11. The continuous track assembly 3 is preferably locked into the frame 11 by latching onto the rear axle 24 of the pushchair 1. For example, the continuous track assembly 3 may include a spring loaded latch which engages a pin on the pushchair 1 or the rear axle 24. Thus, the continuous track assembly 3 becomes an integral part of the pushchair structure and any suspension on the pushchair will be transferred to the continuous track assembly, adding to the smoothness of the ride when the track is in the extended condition.

In order to extend the continuous track assembly 3 and place the lower tread 63b of the belt 63 into contact with the ground, the user pushes on the foot bar 57 with their foot to rotate the bar 57 about the foot bar pivot 59 toward the ground (anticlockwise as viewed in FIG. 3A). This movement pushes the link arm 55 toward the front of the housing 45. In moving forward, the link arm 55 rotates the priming arm gear 51 and, therefore, the priming arm 53. As the priming arm 53 rotates, it slides along the top surface of the running plate 79, forcing the running plate 79 toward the ground. Since the running plate 79 is fixedly connected to the side plates 77, the rotation of the priming arm 53 also forces the side plates 77, base rollers 71, main rollers 69 and roller caps 70 towards the ground. As the running plate 79 is forced toward the ground, the track arms 81 pivot about the end rollers 69, the roller caps 70 slide within the elongate slots 83 and the flexible belt 63 stretches into its expanded condition. Thus, the distance between the lower tread and upper treads 63a, 63b of the belt 63 is increased and the lower tread 63b becomes the lowermost surface of the pushchair 1, which becomes supported by the track assemblies 3 instead of the wheels 17 and 23. A guide channel can be employed to ensure the lower tread 63b and the side plate assembly remain substantially parallel to the upper tread 63a when the continuous track assembly 3 is extended.

When extended, the lower tread 63b of the flexible belt 63 is substantially parallel with the upper tread 63a and the flexible belt 63 forms an angled face 63c at least at the rear of the track assembly 3, and preferably also an angled front face 63d. By presenting an angled face, the continuous track assembly 3 is less likely to become embedded in an obstacle and the pushchair 1 can overcome obstacles by being pushed or pulled, without the need for lifting or tilting. In this expanded condition, the flexible belt 63 is sufficiently taut that it can act as a shock absorber if an obstacle comes into contact with the angled faces of the track which are substantially unsupported in their central regions, i.e. between rollers 65 and 69, and the lower tread 63b can provide traction.

By way of example, with the three wheeled pushchair illustrated, the path defined around the rollers in the retracted position is approximately 1915 mm in length. The length of the belt 63 at rest is approximately 1725 mm, about 10% shorter than the path length. Therefore, the belt 63 remains in tension even in the retracted condition, in order to retain the rollers in that state. In the extended condition, the path length is increased to about 2330 mm, resulting in about 35% extension of the belt 63. Typically, the belt is about 50 mm in width, 3 mm thick and the ridges on the exterior surface for grip are about 5 mm high.

FIG. 5 shows the moulded profile 75 of the belt 63 in detail. The moulded profile 75 is located along the entire length of the inner surface of the belt 63 and clips into a corresponding roller groove 91 on the outer surface of each of the rollers. This ensures the belt 63 runs straight and prevents it from lifting away the rollers, thus avoiding debris from collecting between the belt 63 and rollers.

As shown in FIGS. 6A, 6B and 7, an extendable central pivot assembly 93 is connected to the lower end of each frame side member 13. This can be selectively deployed to become the lowermost surface of the pushchair 1, even when the continuous track assembly 3 is in its expanded condition (see FIG. 7), allowing the pushchair 1 to be pivoted more easily about a vertical axis. Thus, the direction of the pushchair 1 can be changed without the need to overcome an excessive frictional force of the lower tread 63b against the ground and without the need to retract the continuous track assembly 3.

The central pivot assembly 93 comprises a pivot leg 95 which is slidable telescopically relative to the frame side member 13 and has at its distal end a roller 97 rotatably connected to a housing 99. A spring 101 urges the central pivot assembly 93 toward the frame side member 13.

When the continuous track assemblies 3 are in the stowed condition, the central pivot assembly 93 is retracted such that the pivot leg 95 is contained substantially within the frame side member 13. When the continuous track assemblies 3 are moved from the stowed condition to the horizontal position, the central pivot assembly 93 is automatically extended, such that the pivot roller 97 is located just above the ground, as seen in FIGS. 2D and 6A. The central pivot assembly 93 may be further extended and locked in place by means of a cam connected to a cable (not shown but located within the pushchair frame) which is attached to a central pivot actuator 103 located on the handle bar 29. The central pivot assembly 93 then extends further and becomes lower than the lower tread 63b as seen in FIG. 7 so the user can steer the pushchair 1 without needing to retract the continuous track assemblies 3.

In FIG. 6A, the central pivot actuator 103 is shown as a twistable collar on each handle bar 29. Alternatively, the actuators may be in the form of handles 104 as shown in FIGS. 6c and 6d. These are gripped by the user's fingers and pulled up towards the hand grip sections of the handle bar 29, in a similar manner to the brakes on a conventional bicycle handle bar, as shown in FIG. 6D.

With reference to FIGS. 8A, 8B and 8C the seat 5 is provided with means to be reclined automatically when the pushchair 1 is prepared for ascending or descending a steep incline, especially steps. This is of particular importance to ensure the occupant is not tilted at a dangerous angle relative to the horizontal. It also acts to lower the centre of gravity, further reducing the risk of tilting.

The seat base 9 is pivotally connected to the frame 11 by seat base pivots 105 and slidably connected to the frame by seat base supports 107. The seat base supports 107 are located within grooves 109 on the frame side members 13 and are held by seat retaining pins.

Twisting the handle bars 29 about the longitudinal axis of the handle arms 31 from the position shown in FIG. 8A to that shown in FIG. 8B releases the seat retaining means. Subsequently, extending the handle bars 29 out of the handle arms 31 and rotating them about the axis XX relative to the push chair frame causes the seat 5 to recline backwards. To return the seat 5 to the upright position, the user pushes the handle bars 29 back into the handle arms 31, rotates them about axis XX back to their usual angle relative to the pushchair frame 11 and also rotates them about the longitudinal axis of handle arms 31 to return them to their starting position.

With reference to FIGS. 9-13, a method of lowering the pushchair 1 down a flight of stairs is shown.

When the pushchair 1 is at the top of a flight of stairs, the user will put the continuous track assemblies 3 in the deployed and extended condition as described earlier. The user will then rotate each handle bar 29 about the longitudinal axis of the corresponding handle arm 31 to release the handle locking means and release the seat retaining means from the seat base supports 107. Once the handle locking means have been released, the handles 25 can be pivoted about the horizontal axis x-x of the pivot mechanism 27 and the handle bars 29 can be slid telescopically along the longitudinal axes of the handle arms 31. Once the seat base supports 107 are released and the handle bars 29 extended, the seat 5 will recline at an angle to the frame 11 to counteract the decline of the FIG. 9 shows the adjustment range of the handles 25 pivotally about the horizontal axis x-x of the pivot mechanism 27 and slidably along the longitudinal axis of the handle arms 31.

As the continuous tracks pass over the top step, the pushchair 1 pivots under the action of gravity, such that the continuous track assemblies 3 and the pushchair frame 11 are aligned with the gradient of the stair as shown in FIG. 10. Since the handles 25 can be pivoted about the horizontal axis of the pivot mechanism 27 and the handle bars 29 can be extended along the longitudinal axis of the handle arms 31, the handle bars 29 can be matched to the position of the user and remain at a comfortable position when the pushchair 1 descends the stair.

A speed limiter can be fitted to at least one of the continuous track assemblies 3 and may be activated when the handle bars 29 are rotated around the longitudinal axes of the handle arms 31. This will retard the speed of descent, thus enabling the user to regain control of the pushchair 1 should control be temporarily lost.

The lower tread 63b of each continuous track assembly 3 is of such a length that it can span the distance between the nosing of three steps of a standard flight of stairs, as shown in FIG. 10. This reduces the pitch variation of the pushchair 1 whilst descending the stair, providing a smoother operation for the user.

At the bottom of the stair, the angled face of the flexible belt 63 allows the pushchair 1 to return to a horizontal position in a smooth manner and the extendable, pivotable handles 25 afford the user continued control of the descent until the user joins the pushchair 1 on the flat ground (FIGS. 11 and 12).

If the user wishes to change the direction of the pushchair 1 between obstacles, such as on an intermediate landing between two flights of stairs, without contracting the continuous track assemblies 3, they may do so by operating the pivot actuator 103 to extend the central pivot assembly 93.

Once the obstacle has been overcome, the user pushes the handle bars 29 along the longitudinal axis of the handle arms 31 and pivots the handles 25 about the horizontal axis x-x of the pivot mechanism 27 to return the handles 25 to the position desired for normal use, as shown in FIG. 13. Returning the handle bars 29 to the unextended position returns the seat 5 to the upright position and rotating the handle bars 29 to the nominal position reengages the seat retaining means into the seat base supports 107.

To return the continuous track assemblies 3 to the stowed condition, the user pushes on the release pedal 61 with their foot to contract the continuous track assemblies 3. Pushing the release pedal 61 rotates the foot pedal 57 away from the ground (clockwise with reference to FIG. 3A), rotating the priming arm 53 away from the running plate 79 and enabling the tension in the flexible belt 63 to retract the track. Once retracted, the user can manually raise the continuous track assemblies 3 until they reach the stowed position, where the spring loaded release pins 37 automatically engage into their corresponding upper notch 36a to lock the continuous track assemblies 3 in the stowed position.

The method of pulling the pushchair 1 up the stairs is essentially the reverse of the method described above.

The distance between the upper tread 63a and the lower tread 63b is such that the top of the angled face is higher than a standard step. This enables the user to pull the pushchair 1 onto the bottom step without the need to tilt or lift the pushchair 1.

FIGS. 14 and 15 show the pushchair 1 in use on soft or uneven ground such as sand, gravel or rough turf. When the pushchair 1 encounters such ground, with the continuous track assemblies 3 in the retracted and stowed condition, the wheels are likely to become embedded (FIG. 14) and the user must exert excessive force to overcome the obstacle. When the continuous track assemblies 3 are in the deployed and extended condition, the weight of the pushchair 1 is distributed over a larger surface area and the track can ride over the crest of multiple obstacles, enabling the pushchair 1 to negotiate soft or uneven ground without becoming embedded or bogged down (FIG. 15).

It will be appreciated that the foregoing is only one specific example and a number of variations and modifications are possible. For example, although the pushchair 1 is shown having two rear wheels 23 and one front wheel 17 on a front member 15, other arrangements are possible. For example, there may be two front members, located on either side of the front wheel 17. Alternatively, there may be two or more front wheels or only a single rear leg 21.

The two continuous track assemblies 3 have been described for use with a three-wheeled pushchair 1. Since the majority of pushchairs are provided with a front wheel, or set of front wheels, which may swivel to enable steering, the continuous track assemblies 3 must be positioned outside the arc of rotation of the front wheel 17, or wheels. Thus, for a three-wheeled pushchair 1, each continuous track assembly 3 can be positioned close to the rear wheels to minimise the overall width increase of the pushchair. Alternatively, for a four-wheeled pushchair, to avoid increasing the pushchair width, the continuous track assemblies could be positioned within the wheels, beneath the seat. Alternatively, a single, wider continuous trade assembly could be located centrally under the pushchair 1.

The handle 25 may be in the form of two L-shaped handle bars 29, or may comprise one continuous U-shaped handle bar.

Thus, an improved manually propelled vehicle is provided which can easily negotiate steps or uneven ground. It will be appreciated that many other variations and modifications are possible without departing from the scope of the appended claims.

What is claimed is:

1. A manually propelled vehicle comprising:
a frame;
a plurality of wheels secured to the frame for conveying the vehicle in one mode of operation thereof; and
at least one continuous track assembly mounted on the frame and defining an upper tread and a lower tread, wherein a distance between the upper tread and the lower tread changes from a retracted condition to an extended condition, and wherein in the extended condition the lower tread forms a ground engaging surface of the vehicle for conveying the vehicle in a second mode of operation thereof, and further comprising:
a seat pivotably mounted to the frame and a handle operable with the frame to tilt the seat about a horizontal axis when ascending or descending an incline.

2. A manually propelled vehicle as claimed in claim 1 wherein the continuous track assembly comprises an endless, elastic belt and a plurality of rollers defining a path for the belt, wherein some of the rollers are displaced relative to other rollers for setting a longer path for the belt and stretching the belt in the extended condition.

3. A manually propelled vehicle as claimed in claim 2, wherein the belt is in tension in both the retracted and extended conditions.

4. A manually propelled vehicle as claimed in claim 2, further comprising at least one front roller, at least one rear roller, and a plurality of central rollers, the central rollers rotatably secured to a common mounting, and an arm to move the common mounting away from the upper tread to cause the belt to extend.

5. A manually propelled vehicle as claimed in claim 4, further comprising a first release operable in a first direction to rotate the arm and push the common mounting.

6. A manually propelled vehicle as claimed in claim 5, wherein the first release comprises a rotatable foot pedal and a linkage connecting the pedal to the arm.

7. A manually propelled vehicle as claimed in claim 5, further comprising a locking means to retain the continuous track assembly in the extended condition.

8. A manually propelled vehicle as claimed in claim 5, wherein the first release is operable in a second direction, opposite to the first direction, to unlock the locking means and allow the continuous track assembly to return from the extended condition to the retracted condition under action of tension of the belt.

9. A manually propelled vehicle as claimed in claim 2, wherein the belt is formed from neoprene.

10. A manually propelled vehicle as claimed in claim 2, wherein an exterior surface of the belt is provided with an uneven texture.

11. A manually propelled vehicle as claimed in claim 2, wherein an interior surface of the belt is provided with a moulding for engagement with a correspondingly shaped portion of the rollers.

12. A manually propelled vehicle as claimed in claim 2, where the continuous track assembly further comprises a casing partially covering the belt and rollers.

13. A manually propelled vehicle as claimed in claim 1, wherein the continuous track assembly is mounted on the frame for displacement between a stowed position and a deployed position.

14. A manually propelled vehicle as claimed in claim 13, wherein one of the frame or the continuous track assembly further comprises at least one guide pin engaging in and movable along at least one guide slot formed in the other of the frame or the continuous track assembly.

15. A manually propelled vehicle as claimed in claim 13, further comprising a lock operable to lock the continuous track assembly in the stowed position or in the deployed position and a second release operable to release the continuous track assembly and to allow displacement between the stowed and deployed positions.

16. A manually propelled vehicle as claimed in claim 15, wherein the lock comprises a pin resiliently biased by a spring and the second release mechanism comprises a handle and a linkage to move the pin in opposition to the spring.

17. A manually propelled vehicle as claimed in claim 1, wherein in the extended condition, the upper tread is longer than the lower tread and the continuous track assembly defines a rearward facing tread which extends downwardly and forwardly from the upper tread to the lower tread.

18. A manually propelled vehicle as claimed in claim 17, wherein the continuous track assembly defines a forward facing tread which extends downwardly and rearwardly between the upper tread and the lower tread.

19. A manually propelled vehicle as claimed in claim 17, wherein the forward and rearward treads are substantially unsupported in their respective central regions so as to provide a shock absorbing capability.

20. A manually propelled vehicle as claimed in claim 17, wherein the length of the lower tread is sufficient to span the nosing of three steps of a standard flight of steps.

21. A manually propelled vehicle as claimed in claim 1, wherein the distance between the upper tread and the lower tread in the extended condition is greater than the height of the riser of a standard step.

22. A manually propelled vehicle as claimed in claim 13, wherein the continuous track assembly can only be moved between the retracted and extended conditions when the track assembly is in the deployed position.

23. A manually propelled vehicle as claimed in claim 1, further comprising a pivot which can be selectively deployed so as to extend beyond the lower tread of the continuous track assembly when it is in the extended condition in order that the pivot becomes the ground engaging surface of the vehicle in place of the lower tread, to enable steering of the vehicle.

24. A manually propelled vehicle as claimed in claim 23, wherein the pivot comprises as least two rollers mounted on extendible parts of the vehicle frame.

25. A manually propelled vehicle as claimed in claim 1, further comprising a handle for use in manually propelling vehicle.

26. A manually propelled vehicle as claimed in claim 25, wherein the handle is rotatable relative to the frame about two mutually perpendicular axes and is extendable in length.

27. A manually propelled vehicle as claimed in claim 26, wherein when the seat is initially locked in an upright position, rotation of the handle about one axis releases the seat and rotation of the handle about the second axis and extension of the handle is operable to tilt the seat backwards.

28. (canceled)
